(19) United States
(12) Patent Application Publication
(10) Pub. No.: US 2019/0139651 A1
(43) Pub. Date: May 9, 2019

(54) High Radiation Efficiency Non Fissile Shell for ICF

(71) Applicants: Eric W. Cornell, Colorado Springs, CO (US); Robert O. Hunter, JR., Aspen, CO (US); David H. Sowle, Santa Maria, CA (US); Adlai H. Smith, Escondido, CA (US)

(72) Inventors: Eric W. Cornell, Colorado Springs, CO (US); Robert O. Hunter, JR., Aspen, CO (US); David H. Sowle, Santa Maria, CA (US); Adlai H. Smith, Escondido, CA (US)

(73) Assignee: Innoven Energy LLC, Colorado Springs, CO (US)

(21) Appl. No.: 15/980,440

(22) Filed: May 15, 2018

Related U.S. Application Data
(60) Provisional application No. 62/517,402, filed on Jun. 9, 2017.

(51) Int. Cl. G21B 1/19; G21C 21/02; G21B 1/01

(52) U.S. Cl. CPC G21B 1/19; G21B 1/01; G21C 21/02

(57) ABSTRACT

In a system and method for utilizing a non-fissile fissionable shell material in a target assembly for Inertial Confinement Fusion (ICF). In one embodiment, the target assembly comprises a central region and a first shell surrounding said central region, wherein said central region receives a fusion fuel mixture and said first shell is a non-fissile fissionable material having a Z greater than 48. By proper configuration of the high-Z shell's fissionable properties, and the timing, the 14 MeV neutrons provide sufficient energy deposition into the shell that it expands at the requisite rate during the implosion, you can get an intrinsically stable implosion.

### CROSS-REFERENCE TO RELATED APPLICATIONS

This application claims the benefit of U.S. Provisional Application No. 62/517,402 filed on Jun. 9, 2017, which is incorporated herein by reference.

### BACKGROUND

Inertial Confinement Fusion (“ICF”) is a process by which energy is produced by nuclear fusion reactions. The fuel pellet, generally called the target, is conventionally a spherical device which contains fuel for the fusion process. Various ways of driving and imploding the target have been utilized and considered (lasers, ion beams, etc.). These drivers transfer energy to the target which then implodes and ignites the fuel. If the fuel is sufficiently heated and compressed, a self-sustaining fusion reaction occurs, wherein the fuel self-heats and produces energy from the fusion reaction.

If the target is to be useful for energy production, it must output more energy than the amount of energy needed to drive the implosion. The amount of energy needed to drive the target may be quite high as very high temperatures and densities are required to initiate fusion reactions. Also, the amount of energy needed to drive the target must be physically and economically achievable.

The conventional approach to ICF target design is exemplified by the Department of Energy's program, NIF (National Ignition Facility). NIF target designs, as described in Lindl, “The Physics Basis for Ignition Using Indirect Drive Targets on the National Ignition Facility,” consists of a mostly plastic or beryllium ablator region which surrounds a cryogenic DT ice, and a central void which is filled with very low density DT gas. The target is then placed in a cylindrical hohlraum. The entire target assembly (hohlraum and target) is then placed in the target chamber, where a 192 beamline laser delivers up to 1.8 MJ of energy to the hohlraum. The hohlraum then converts the energy to x-rays which then ablate the ablator region, and by the reactive force, drives the DT shell inward.

However, NIF targets have, up to now, never ignited. The areal density (ρr) of the fuel and the temperature of the fuel has, to date, fallen short of the 0.3 g/cm² and 10 keV they believe they require. It is not clear why the NIF targets have not achieved ignition, but it may be due to lower than expected shell velocities and greater than expected Raleigh-Taylor instability growth which may be due to low fall lines.

Although NIF targets utilize a DT shell, gold shells have been considered by K. S. Lackner, S. A. Colgate, N. L. Johnson, R. C. Kirkpatrick, R. Menikoff and A. G. Petschek “Equilibrium Ignition for ICF Capsules”, 11^{th} International Workshop on Laser Interaction and related Plasma Phenomena, Monterey, Calif., Oct. 25-29, 1993. High Z shells have the effect of trapping the radiation in the DT core, thereby allowing the radiation field to reach its equilibrium blackbody spectrum and lowering ignition temperatures to about 2.5 keV. ICF has been hampered for the last many decades by stability and symmetry considerations. Lackner et al. proposed using high-Z shells and they realized the advantage of the low ignition temperature that would occur therein. However, the ICF community largely rejected high-Z shells on the grounds that the mix of the high-Z material with the fuel would tend to quench any of the reactivity of the fuel.

Unless otherwise indicated herein, the material described in this section are not prior art to the claims in this application and are not admitted to be prior art by inclusion in this section.

### SUMMARY

This has heretofore been unrecognized, by utilizing a fissionable shell, you favorably affect the stability properties of the implosions resulting in minimal mix because of suppressed Raleigh-Taylor instability. The result is an intrinsically stable implosion. By proper configuration of the high-Z shell's fissionable properties, and the timing, the 14 MeV neutrons provide sufficient energy deposition into the shell that it expands at the requisite rate during the implosion, you can get an intrinsically stable implosion.

Another aspect of this invention is how to reach high radiation temperatures with a high-Z shell. Radiation has not normally been proposed as the preferred output of an ICF target. At high enough radiation output temperatures (˜1 keV) where it becomes the dominant output or equivalently at high radiation yields (per unit mass), fusion reactor configurations become simpler or more effective because of the shift in the proportions of radiation, neutron, and debris energy output.

A third aspect of the invention is high energy yielding targets, or for a target of smaller total mass, we achieve the same net energy but a higher proportion as radiation.

A fourth aspect of this invention is the ability to achieve equivalent yields with lower drive energies.

### DRAWINGS

FIG. 1 shows an embodiment where a high Z shell surrounds a fuel region.

FIG. 2 shows an embodiment where a high Z shell surrounds a high density fuel region which surrounds a low density fuel region.

FIG. 3 shows an embodiment where a high density fuel region is lined with a high Z material surrounding a low density fuel region.

FIG. 4 shows a definition of the fall line parameter.

### DESCRIPTION AND EMBODIMENT

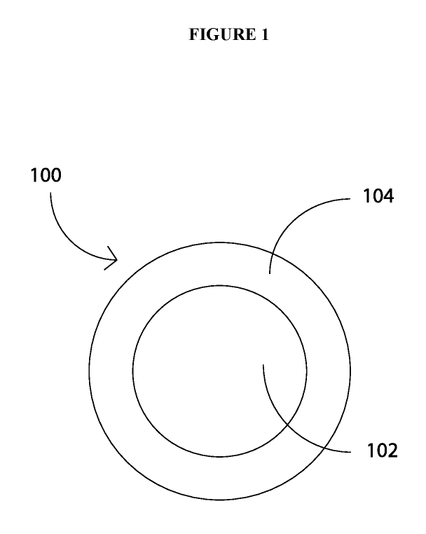

A first embodiment 100 of this invention is shown in FIG. 1 (not to scale). The embodiment is comprised of a high Z shell 104 (wherein high Z refers to elements of atomic number greater than or equal to 48) which surrounds a fuel region 102. Fuel region may be filled with equimolar deuterium and tritium (DT). In some embodiments fuel region 102 may have a higher ratio of deuterium to tritium, or conversely, a higher ratio of tritium to deuterium. Fuel region 102 could be filled with other types of fusion fuel such as: pure deuterium, lithium deuteride, lithium tritide, or any other fusion fuel or combination of fuels. The high Z shell 104 may implode, if sufficiently driven by ways known in the art, such as ablation of an outer ablator region or other methods known in the art. This inward motion of the shell 104 may launch a shock into the fuel region 102 which may sufficiently heat the fuel region 102, and simultaneously, the shell 104 may compress the fuel region 102 and cause it to ignite and burn a signification fraction of the fuel. For this discussion we will assume that half of the fuel burns (f_{b}=0.5), although more or less is possible. Once fuel region 102 ignites, each fusion reaction produces a 14 MeV neutron and a 3.5 MeV α particle. The 14 MeV neutron will likely escape the target assembly if the areal densities (ρΔr) of fuel region 102 and shell 104 are small at the time of ignition. The 3.5 MeV α particle will deposit locally in fuel 102 (if the ρΔr of the fuel is greater than 0.3 g/cm²). The deposition of the α particles then leads to a sustained fuel burn. Thus, the shell/fuel assembly 100 will be heated by about

$$\frac{3.5 MeV}{17.5 MeV} = 20 \% of the energy released from fusion reactions .$$

It may be advantageous to make shell 104 of a material that can convert neutron energy to thermal energy. The shell 104 material is exemplified by ²³⁸U and ²³²Th, both of which have fission cross sections at 14 MeV that are substantial. Table 1 gives the approximate cross sections.

TABLE 1
14 MeV Fission Cross Sections (σ_{ff} in barns = 10⁻²⁴ cm²)

| Material | σ_{ff} |
|---|---|
| ²³⁸U | 1.0 |
| ²³²Th | 0.5 |

For a class of simple targets 100 using single shell 104 and about 10⁻³ g of DT (m_{f}=1 mg), the ϕΔrₛ of the shell 104 at the time when the fuel 102 ignites ranges from 5-10 g/cm² depending on the shell to fuel mass ratio (mₛ/m_{f}). Table 2 gives the probability of 14 MeV neutrons to cause fast fissions

$$( {p}_{f} = ρΔ {r}_{s} \frac{N {σ}_{ff}}{A} )$$

and the local thermal energy thereby produced. Table 2 assumes 200 MeV local energy release with no further fissions due to the daughter neutrons. Definitions for column titles are as follows: pf is the probability of a neutron to cause a fast fission, E_{TOT(DT)} is the total energy released by the DT, E_{DT} Thermal is thermal energy released by the DT, E_{TOT} Thermal is the combined thermal energy released by the DT and by fissions in the shell, E_{TOT} is the total amount of energy released.

TABLE 2
Properties of Target with Shell Fissioned by 14 MeV Neutrons for
ρΔrₛ = 10 g/cm², m_{f} = 2 mg, f_{b} = 0.5

| | p_{f} | E_{TOT(DT)} | E_{DT} Thermal | E_{TOT} Thermal | E_{TOT} |
|---|---|---|---|---|---|
| ²³⁸U | .025 | 3 × 10⁸ J | 6 × 10⁷ J | 1.45 × 10⁸ J | 3.85 × 10⁸ J |
| ²³²Th | .013 | 3 × 10⁸ J | 6 × 10⁷ J | 1.04 × 10⁸ J | 3.44 × 10⁸ J |

Table 3 gives the local deposited energy to mass ratio where the mass includes allowance for an ablator mass (mₐ), hohlraum wall mass (mₕ), and shell mass (mₛ) for a typical target driven by a radiation field produced in a hohlraum.

TABLE 3
Ratio of Thermal Energy Available to Mass for Target in Table 2 with
mₛ/m_{f} = 40, mₐ/mₛ = 10, mₕ/m_{f} = 15

| | EThermal | Total Mass | Yield (Thermal)/Mass |
|---|---|---|---|
| ²³⁸U | 3.85 × 10⁸ J | 0.832 g | 4.63 × 10⁸ J/g |
| ²³²Th | 3.44 × 10⁸ J | 0.832 g | 4.13 × 10⁸ J/g |
| No Fission | 6 × 10⁷ J | 0.832 g | 7.2 × 10⁷ J/g |

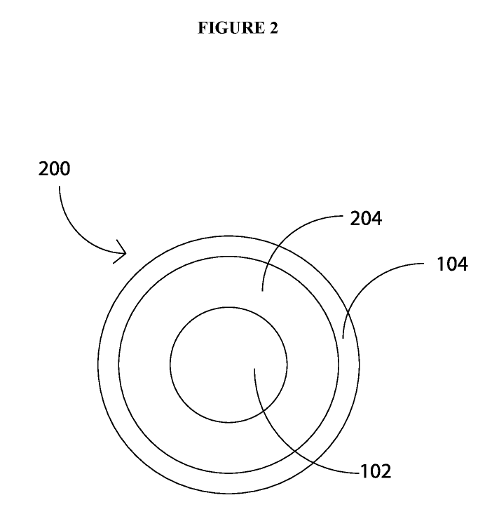

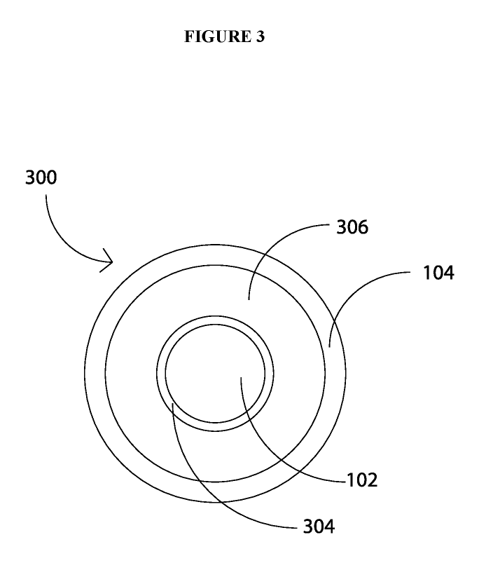

The above were computed for a configuration such as the embodiment 100 seen in FIG. 1. Of course, laminated and mixed or layered shells may be utilized. An embodiment such as a hotspot configuration 200 seen in FIG. 2, where a low density fuel region 102 is ignited by the inward motion of high density fuel region 204 resulting from the ablation of a medium Z (wherein medium Z refers to elements of atomic number 6-48) or low Z (wherein low Z refers to elements of atomic number 5 or less) outer ablator layer (not pictured) or driven by other ways known in the art. A combination of embodiments 100 and 200, can be seen in FIG. 3. In assembly 300, a high density fuel region 306 which is lined with a high Z material 304 which surrounds a low density fuel hotspot region 102.

From Table 3, we see that substitution of fissionable materials in the shell may increase the energy available for radiation by up to a factor of roughly 10 for assembly 100. Also, if the mₐ/mₛ ratio is lowered to some 2:1, the yield per mass would then be further increased by a factor of 3.35 since

$${m}_{total} = {m}_{f} ( 1 + \frac{{m}_{h}}{{m}_{f}} + \frac{{m}_{a}}{{m}_{s}} \frac{{m}_{s}}{{m}_{f}} + \frac{{m}_{s}}{{m}_{f}} ) .$$

At an approximate heat capacity of 10⁸ J/g, the case without fission would result in an output temperature of about 720 eV, the ²³⁸U case, about 6.1 keV, and the mₐ/mₛ=2 case with ²³⁸U, about 20 keV. In some embodiments the majority of the yield from the target may be in the form of radiation, for instance if the output temperature is above 1 keV and the thermal yield per mass (Yₜₕ/m) is greater than 10⁸ J/g. When the fast neutron fluence becomes large enough, much of the shell material will be fissioned. A value,

$${Φ}_{n} = \frac{1}{{σ}_{ff}} ,$$

characterizes this transition.

Using a computer simulation to calculate the thermal yield of a target utilizing ²³⁸U for the high Z shell material 104 in assembly 100 seen in FIG. 1, the following example target: 2 mg DT, mₛ/m_{f}=40, and mₐ/mₛ=2 gives a thermal yield of 140 MJ. A target utilizing a high Z material such as tungsten would give a thermal yield of 42 MJ, a factor of 3.33 decrease from the ²³⁸U case. Given a total mass, including the hohlraum, of 0.35 grams, the Yₜₕ/m=5×10⁸ J/g. The same target without fissionable material would provide 1.3×10⁸ J/g, a factor of 3.8 decrease from the ²³⁸U case.

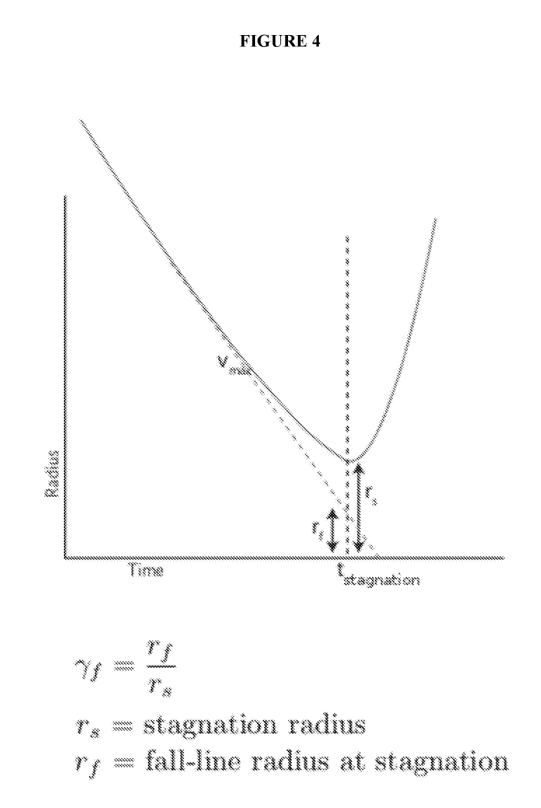

Another unexpected result of the substitution of fissionable material is control of the fall line of the target. The fall line parameter (γ_{f}) is defined as the radius at which the shell/fuel interface would have been ignoring effects of deceleration divided by the radius of the interface including the effects of deceleration at the time of stagnation of the shell/fuel interface (see FIG. 4). As shell 104 begins to fission, shell 104 will begin to heat and expand. This expansion will prevent some of the deceleration of the material interface between shell 104 and fuel region 102. Preventing deceleration of the interface may reduce the amount of Raleigh-Taylor growth of instabilities at the interface, thereby decreasing thermal energy loss from fuel region 102 to shell 104.

In some embodiments, like the one in FIG. 3, low Z region 306 may reach a ρΔr sufficiently large enough at the time fuel region 102 ignites to capture neutrons attempting to pass through the region. These 14 MeV neutrons will then be down-scattered to lower energies. These lower energy neutrons may then be absorbed by the fissionable material in region 104, which may have a larger capture cross section for those lower energy neutrons and increase the amount of material fissioned.

These advantages may lead to lower energy requirements for the drive mechanism (laser, ion beam, etc.) by reducing thermal losses to shell 104, increasing thermal yield from shell 104, and causing ignition earlier in time. Most ICF target designs have some amount of ignition margin built into their designs. Ignition margin can be defined in many ways, but overall ignition margin means robust ignition that is insensitive to noise levels in the drive and instability growth. The invention discussed here then allows that a target design with good ignition margin can be redesigned at lower drive energy while keep the ignition margin constant by the replacement of a non-fissionable shell with a fissionable shell. Lower drive energies are desirable as the driver in most ICF systems is the greatest portion of the cost.

Embodiments of this invention discussed in this application were designed using numerical simulations and hand calculations. This design process necessarily involves making approximations and assumptions. The description of the operation and characteristics of the embodiments presented above is intended to be prophetic, and to aid the reader in understanding the various considerations involved in designing embodiments, and is not to be interpreted as an exact description of how embodiments will perform, an exact description of how various modifications will change the characteristics of an embodiment, nor as the results of actual real-world experiments.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g. size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. A target assembly for Inertial Confinement Fusion utilizing a non-fissile fissionable material, the target assembly comprising:
a central region, wherein said central region receives a fusion fuel mixture; and
a first shell surrounding said central region, wherein said first shell is a non-fissile fissionable material having a Z greater than 48.

2. The target assembly of claim 1, further comprising:
a second region, wherein said second region surrounds said central region;
said central region receives a low-density fusion fuel mixture; and
said second region receives a high-density fusion fuel mixture.

3. The target assembly of claim 2, further comprising a second shell, wherein said second shell directly surrounds said second region which directly surrounds said first shell which directly surrounds said central region.

4. The target assembly of claim 3, wherein said second shell comprises a medium Z material, having a Z within the range and including 6 and 48 or a high Z material, having a Z greater than 48 and may be a fissionable material.

5. The target assembly of claim 3, wherein said first shell and said second shell comprises a plurality of materials in a laminated, mixed or layered fashion.

6. The target assembly of claim 5, wherein the plurality of materials comprises either Uranium-238 or Thorium-232.

7. The target assembly of claim 3, wherein said fusion fuel mixture comprises deuterium and tritium fuel.

8. A method for extracting more controllable energy from imploding a target assembly for Inertial Confinement Fusion, the method comprising:
constructing a target assembly comprising:
receiving a fusion fuel mixture in a central region;
surrounding said central region with a first shell containing a non-fissile fissionable material having a Z greater than 48;
means for impinging x-ray radiation upon said target assembly;
means for compressing said central region by accelerating inwardly said first shell;
producing fissions within said first shell, wherein the fissions produce more fissions;
decreasing deceleration of material at a region above an interface between said central region and said first shell; and
decreasing thermal energy loss from said central region and increasing thermal yield from said second shell.

9. The method of claim 8, further comprising:
structuring a second region surrounding said central region within said target assembly;
further structuring said central region with a low-density fusion fuel mixture; and
structuring said second region with a high-density fusion fuel mixture.

10. The method of claim 9, further comprising:
structuring a second shell within said target assembly; and
constructing said target assembly such that said second shell directly surrounds said second region which directly surrounds said first shell which directly surrounds said central region.

11. The method of claim 10, further comprising: structuring said second shell with a medium Z material, having a Z within the range and including 6 and 48 or a high Z material, having a Z greater than 48 and may be a fissionable material.

12. The method of claim 10, comprising: structuring said first shell and said second shell with a plurality of materials in a laminated, mixed or layered fashion.

13. The method of claim 12, wherein the step of structuring said first shell and said second shell with a plurality of materials comprises either Uranium-238 or Thorium-232.

14. The method of claim 10, further comprising: structuring said fusion fuel mixture with a deuterium and tritium fuel.

15. A method for extracting more controllable energy from imploding a target assembly for Inertial Confinement Fusion, the method comprising:
constructing a target assembly comprising:
receiving a low-density fusion fuel mixture in a central region;
surrounding said central region with a first shell containing a non-fissile fissionable material having a Z greater than 48;
surrounding said first shell with a second region containing a material having a Z lower than 6;
surrounding said second region with a second shell containing a non -fissile fissionable material having a Z greater than 48;
means for impinging x-ray radiation upon said target assembly;
means for compressing said central region by accelerating inwardly said first shell;
producing fissions within said first shell and said second shell;
absorbing higher energy neutrons within said second region and absorbing lower energy neutrons within said first and second shell as the fissionable material within said first and second shell continues to fission; and
decreasing thermal energy loss from said central region.

16. A target assembly for Inertial Confinement Fusion, the target assembly consisting only of:
a central region;
a first shell directly surrounding said central region;
wherein said central region receives a fusion fuel mixture; and
wherein said first shell is a non-fissile fissionable material having a Z greater than 48.

17. The target assembly of claim 16, wherein said first shell comprises a plurality of materials in a laminated, mixed or layered fashion.

18. The target assembly of claim 17, wherein the plurality of materials comprises either Uranium-238 or Thorium-232.

19. The target assembly of claim 16, wherein said fusion fuel mixture comprises a low -density fusion fuel mixture or a high-density fusion fuel mixture.

20. The target assembly of claim 16, wherein said fusion fuel mixture comprises deuterium and tritium fuel.
